(19) United States
(12) Patent Application Publication
(10) Pub. No.: US 2014/0253790 A1
(43) Pub. Date: Sep. 11, 2014

(54) FILTER WITH FIRST POLARIZED PORTION AND A SECOND POLARIZED PORTION

(71) Applicants: Kevin James Matherson, Windsor, ID (US); Andrew C Goris, Loveland, CO (US); Dan L Dalton, Greeley, CO (US)

(72) Inventors: Kevin James Matherson, Windsor, ID (US); Andrew C Goris, Loveland, CO (US); Dan L Dalton, Greeley, CO (US)

(73) Assignee: Hewlette-Packard Development Company, L.P., Fort Collins, CO (US)

(21) Appl. No.: 14/009,259

(22) PCT Filed: Jun. 30, 2011
(86) PCT No.: PCT/US2011/042725

§ 371 Date: Oct. 1, 2013

(51) Int. Cl. H04N 5/225

(52) U.S. Cl. CPC H04N 5/2254; H04N 5/2256
USPC 348/361

(57) ABSTRACT

A portable device including a light source, an image capture component with an image sensor, a filter with a first polarized portion and a second polarized portion, a mechanism to reposition the filter to overlap the light source with the first polarized portion of the filter and overlap the image sensor with the second polarized portion of the filter, and a controller to capture visual media with the image capture component.

### BACKGROUND

If a user would like to capture an image of a document or whiteboard in an environment without sufficient lighting, the user can use a flash or strobe light to illuminate the document or the whiteboard. The user can then capture an image of the illuminated document or whiteboard with an image capture component. The captured image may include hot spots resulting from fight reflecting from the surface of the document or the whiteboard. As a result, part of the image may not be clear or the image may not be legible. The user can use an image editing application to modify and/or edit areas of the captured image to compensate for the hot spots. This can sometimes lead to black or colored text being removed from the captured image or the black or colored text being converted to white text.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a device with an image capture component, a light source, and a filter according to an embodiment.

FIG. 2A and FIG. 2B illustrate a first polarized portion of a filter and a second polarized portion of the filter according to embodiments.

FIG. 3 illustrates a block diagram of a mechanism for repositioning a filter according to an embodiment.

FIG. 4 illustrates image capture component detecting reflections on a surface of a media according to an embodiment.

FIG. 5 illustrates a block diagram of a mechanism repositioning a filter to cover a light source and an image sensor in response to an image application detecting reflections on a surface of media according to an embodiment.

FIG. 6 is a flow chart illustrating a method for capturing visual media according to an embodiment.

FIG. 7 is a flow chart illustrating a method for capturing visual media according to another embodiment.

### DETAILED DESCRIPTION

A device can be used to capture visual images and/or videos of media as visual media. The media can be a document, a whiteboard, and/or any additional form of physical media. By detecting for light reflected from a surface of the media, a device can determine whether the visual media, captured by the device, includes one or more hot spots. For the purposes of this application, a hot spot can be an over exposed area of an image or video which results from ambient light or device outputted light reflecting from a surface of the media. An over exposed area can correspond to an area of the image which may be brighter than expected or desired by a user and can appear too bright, glossy and/or blurry. The surface can be a top or outer layer or coating of the media.

If a reflection or hot spot is detected, the device can position a first polarized portion of a filter to overlap a light source of the device. Additionally, a second polarized portion of the filter can be positioned to overlap an image sensor of an image capture component of the device. As a result, light from the light source can be outputted from the first polarized portion of the filter and the image capture component can capture visual media of the media through the second polarized portion of the filter. By outputting light through a first polarized portion of the filter, polarized light from the light source can be filtered. Additionally, by capturing the visual media through the second polarized portion of the filter, polarized light reflecting from the surface of the media can be filtered for the image capture component to capture the visual media. As a result, an amount of hot spots on captured visual media can be reduced, leading to a user friendly experience when capturing visual media.

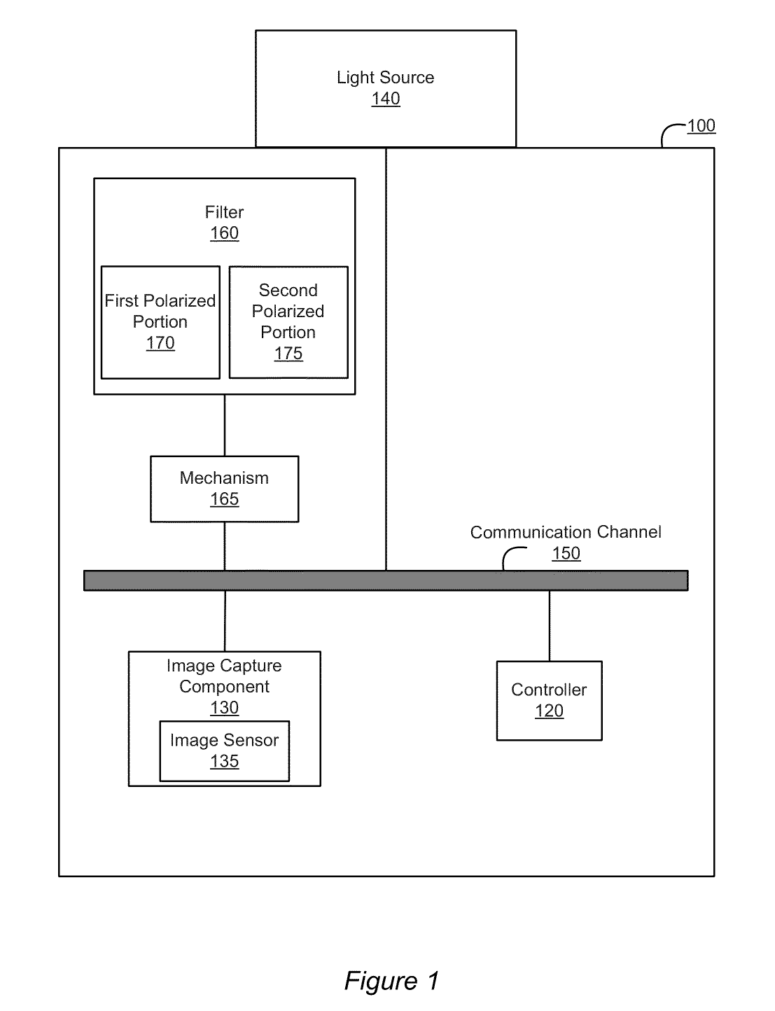

FIG. 1 illustrates a device 100 with an image capture component 130, a light source 140, and a filter 160 according to an embodiment. In one embodiment, the device 100 can be a cellular device, a PDA (Personal Digital Assistant), an E (Electronic)-Reader, a tablet, a camera, and/or the like. In another embodiment, the device 100 can be a desktop, a laptop, a notebook, a tablet, a netbook, an all-in-one system, a server, and/or any additional device which can be coupled to an image capture component 130, a light source 140,1 and a filter 160.

As illustrated in FIG. 1, the device 100 includes a controller 120, a light source 140, an image capture component 130, a mechanism 165, a filter 160, and a communication channel 150 for the device 100 and/or one or more components of the device 100 to communicate with one another. In one embodiment, the device 100 includes an image application stored on a computer readable medium included in or accessible to the device 100. In other embodiments, the device 100 includes additional components and/or is coupled to additional components in addition to and/or in lieu of those noted above and illustrated in FIG. 1.

As noted above, the device 100 can include a controller 120. The controller 120 can send data and/or instructions to the components of the device 100, such as the light source 140, the image capture component 130, the mechanism 165, and/or the image application. Additionally, the controller 120 can receive data and/or instructions from components of the device 100, such as the light source 140, the image capture component 130, the mechanism 165, and/or the image application.

The image application is an application or a firmware of the device 100 which can be utilized in conjunction with the controller 120 to manage the device 100 when capturing visual media. Visual media can be a two dimensional and/or a three dimensional image or video of media captured by an image capture component 130 of the device 100. The media can be a document, such as a book, a magazine, a newspaper, a journal, a calendar, and/or any additional form of physical media. Additionally, the media can be a whiteboard, such as a wall, a plastic surface, a glass surface, and/or any additional object with a surface including text and/or an image.

For the purposes of this application, an image capture component 130 is a hardware component of the device 100 configured to capture the visual media using an image sensor 135. The image sensor 135 can be a component utilized by the controller 120 and/or the image application to convert an optical image of a document and/or a whiteboard into an electrical signal for the controller 120 and/or the image application to capture the visual media. The image sensor 135 can include a CCD (charge coupled device) image sensor and/or a CMOS (complementary metal oxide semiconductor) sensor.

When capturing the visual media, a light source 140 of the device 100 can be used by the controller 120 and/or the image application to illuminate the media. The light source 140 can be a strobe light and/or a flash component of the device 100 configured to output one or more flashes of light. If the light source 140 is used to illuminate the media, a filter 160 can be used to overlap the light source 140 and the image sensor 135 of the image capture component 130.

For the purposes of this application, the filter 160 can be an optical or a photographical filter which can be positioned to overlap a light path of the light source 140 and/or to overlap an optical path of the image sensor 135. The filter can include a first polarized portion 170 and a second polarized portion 175. The first polarized portion 170 and/or the second polarized portion 175 can filter polarized light outputted from the light source 140 and filter polarized light received by the image sensor 135. In one embodiment, both the first polarized portion 170 and the second polarized portion 175 can be linearly polarized. The first polarized portion 170 and the second polarized portion 175 can be orthogonally polarized relative to one another. In another embodiment, both the first polarized portion 170 and the second polarized portion 175 can be circularly polarized.

A mechanism 165 of the device 100 can be used to reposition the filter 160. For the purposes of this application, the mechanism 165 is a hardware component of the device 100 configured to reposition the filter 160 from one position to another. If positioned in a first position, the filter 160 does not overlap the image sensor 135 and/or the light source 140. If repositioned from the first position to a second position, the filter 160 overlaps the light source 140 and/or the image sensor 135. The mechanism 165 can include one or more hinges or rails for the filter 160 to be repositioned. The filter 160 can be with repositioned with the mechanism 165 by sliding along one or more axis and/or by rotating around one or more axis. In one embodiment, a user can manually reposition the filter 160 by moving the filter 160 from one position to another with the mechanism 165. In another embodiment, the mechanism 165 can further include a motor and/or a spring configured to automatically position the filter 160 from one position to another.

By using the mechanism 165 to reposition the filter 160, the light path of the light source 140 can be overlapped with a first polarized portion 170 of the filter and polarized light outputted from light source 140 can be filtered. Additionally, by overlapping the optical path of the image sensor 135 with the filter 160, polarized light reflected from a surface of the media can be filtered by the second polarized portion 175 of the filter 160. For the purposes of this application, a surface includes a top or outer layer or coating of the media. As a result, an amount of reflections can be reduced as visual media is captured by the image sensor 135 of the device 100.

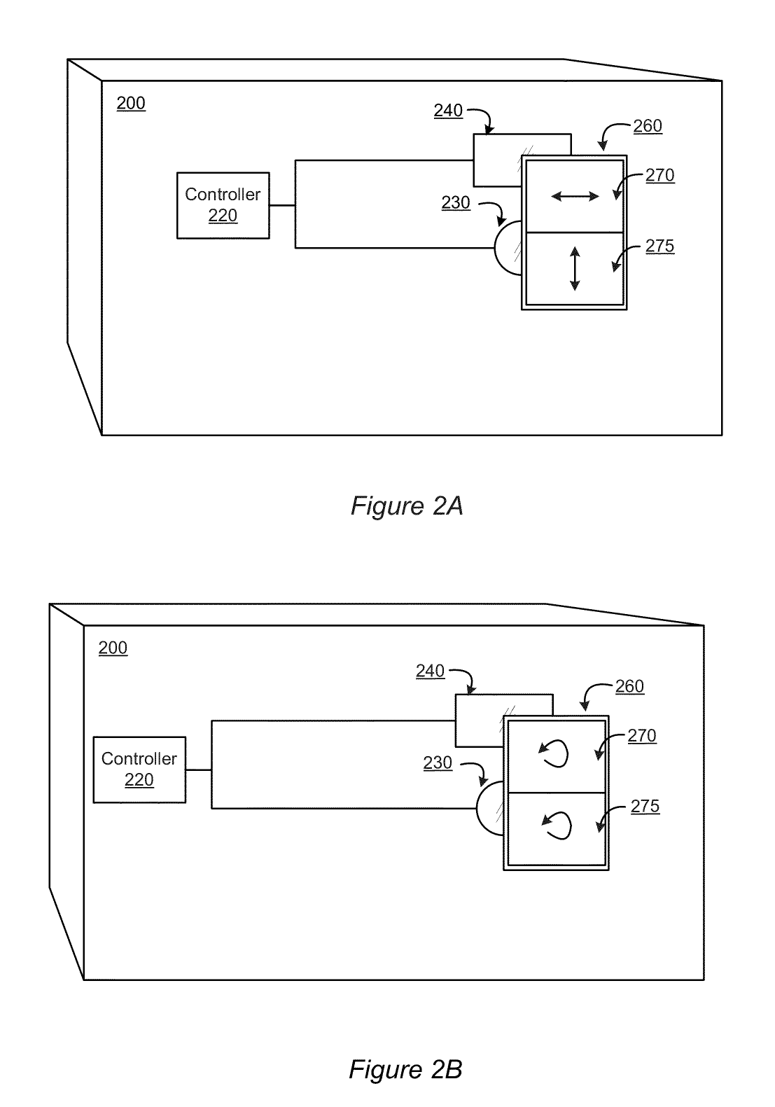

FIG. 2A and FIG. 2B illustrate a first polarized portion 270 of a filter 260 and a second polarized portion 275 of the filter 260 according to embodiments. The filter 260 can be an optical or photographic filter which can overlap a light path of a light source 240 and overlap an optical path of an image sensor of the image capture component 230. The filter 260 can include a composition of glass, plastics, and/or a combination of glasses and/or plastics. In other embodiments, a composition of the filter 260 can include other additional elements or combination of elements in addition to and/or in lieu of those noted above.

As noted above, the first portion 270 and the second portion 275 of the filter 260 can be polarized. The first portion 270 and the second portion 275 of the filter 260 can be polarized by applying one or more coatings, films, and/or layers to the top half and bottom half of the filter 260. In other embodiments, the first portion 270 and the second portion 275 can be polarized using other methods in addition to and/or in lieu of those noted above.

In one embodiment, as shown in FIG. 2A, the first polarized portion 270 and the second polarized portion 275 can be linearly polarized. Additionally, the first polarized portion 270 and the second polarized portion 275 are orthogonally polarized. For the purposes of this application, the first polarized portion 270 and the second polarized portion 275 are orthogonally polarized if the linear polarization of one portion of the filter 260 is polarized at 90 degrees relative to the linear polarization of the other portion of the filter 260.

In one embodiment, if the first polarized portion 270 and the second polarized portion 275 are orthogonally polarized, one portion of the filter 260 is horizontally polarized while another portion of the filter 260 is vertically polarized. As a result, the first polarized portion 270 can filter linearly polarized light outputted from the light source 240 along one axis, while the second polarized portion 275 can filter linearly polarized light received by the image sensor along another axis.

In another embodiment, as illustrated in FIG. 213, the first polarized portion 270 and the second polarized portion 275 of the filter 260 can be circularly polarized. If the first polarized portion 270 and the second polarized portion 275 are circularly polarized, a direction of the polarization can additionally be reversed such that both portions of the filter 260 follow a counter clockwise direction. As a result, the light outputted from the light source 240 through the first polarized portion 270 can be circularly polarized while the second polarized portion 275 can absorb or filter the circularly polarized light for the image sensor of the image capture component 230.

As shown in FIG. 2A and FIG. 2B, the first polarized portion 270 and the second polarized portion 275 can be positioned to overlap the light source 240 and an image sensor of the image capture component 230. The light source 240 is a hardware component of the device 200 configured to output fight for the image capture component 230 to capture visual media. The fight source 240 can output the light continuously or by emitting the light in flashes. In one embodiment, the light source 240 can be a strobe light which includes one or more bulbs. One or more of the bulbs can include xenon bulbs or LEDs (light emitting diodes).

The image capture component 230 is a hardware component of the device 200 which includes an image sensor to capture an optical image and convert the optical image into an electronic signal when capturing visual media. The image capture component 230 can be a camera, a webcam, a scanner, a photo sensor, and/or any additional device which can include an image sensor. The image sensor can include a CCD (charge coupled device) image sensor and/or a CMOS (complementary metal oxide semiconductor) sensor.

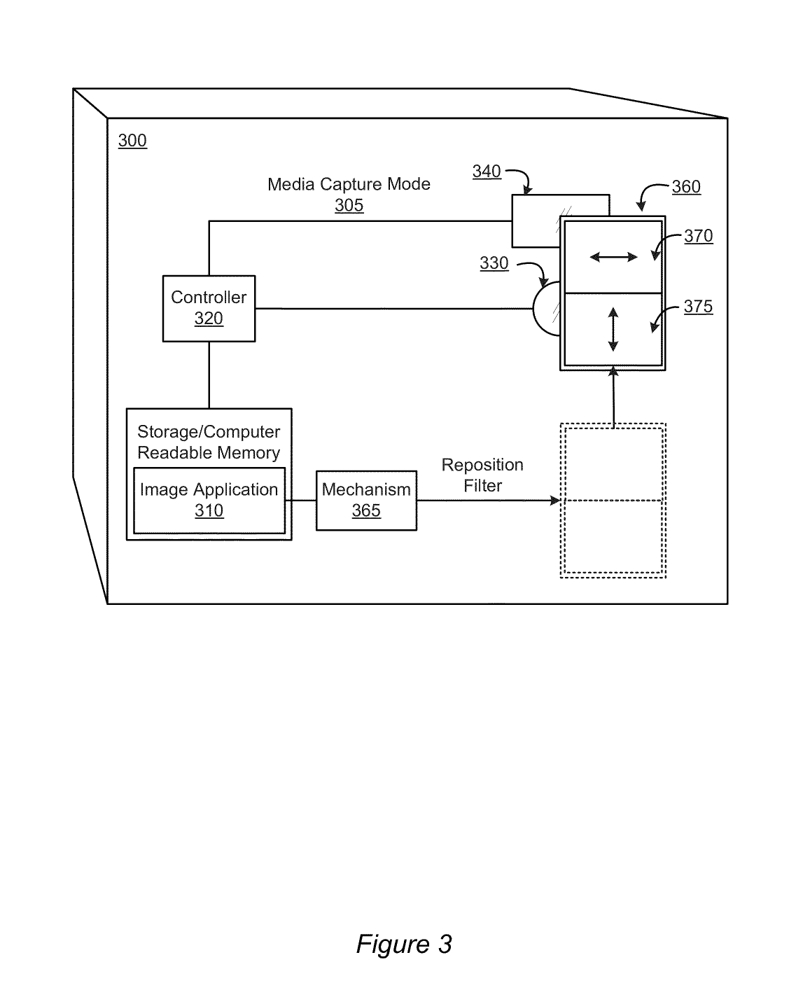

FIG. 3 illustrates a block diagram of a mechanism 365 for repositioning a filter 360 according to an embodiment. As shown in FIG. 3, the filter 360 can initially be positioned in a first position. If in the first position, the filter 360 does not overlap the light source 340 and the image sensor of the image capture component 330. A mechanism 365 can be used to reposition the filter 360 from the first position to a second position, such that a first polarized portion 370 of the filter 360 overlaps the light source 340 and a second polarized portion 375 of the filter 360 overlaps the image capture component 330.

As noted above, the mechanism 365 is a hardware component of the device 300 for repositioning the filter 360 from one position to another. The mechanism 365 can include a tray and/or one or more rails utilized to slide the filter 360 from one position to another. In another embodiment, the mechanism 365 can include one or more hinges to rotate the filter 360 from one position to another. In other embodiments, the mechanism 365 can further include one or more locking mechanisms to lock the filter 360 in one or more of the positions. A locking mechanism can be a latch, a spring latch, and/or any additional component to secure the filter 360 in one or more positions.

In one embodiment, a user of the device 300 can manually access the mechanism 365 to reposition the filter 360 from one position to another. The user can slide the filter 360 from one position to another along the rails of the mechanism 365. In another embodiment, the user can rotate the filter 360 from one position to another using a hinge of the mechanism 365. In other embodiments, the mechanism 365 can include a motor and/or a spring to automatically reposition the filter 360 from one position to another upon instruction from the controller 320, the image application 310, and/or the user.

The mechanism 365 can be instructed by the controller 320 and/or the image application 310 to reposition the filter 360 to overlap the light source 340 and the image sensor of the image capture component 330 in response to the device 300 powering on. Additionally, the mechanism 365 can be instructed by the controller 320 and/or the image application 310 to reposition the filter 360 to not overlap the light source 340 and the image sensor of the image capture component 330 in response to the device 300 powering off. In other embodiments, the mechanism 365 can be instructed by the controller 320 and/or the image application 310 to reposition the filter 360 based on a mode of operation of the device 300.

The device 300 can enter or transition into the media capture mode 305 upon receiving an instruction from a user and/or in response to the controller 320 and/or the image application 310 detecting one or more reflections from a surface of media. For the purposes of this application, a mode of operation can include an operation state or activity of the device 300. In one embodiment, a mode of operation includes a media capture mode 305. The device 300 is in a media capture mode 305 if the device 300 is to be used to capture visual media of media. When in the media capture mode 305, the image capture component 330 and the light source 340 are enabled. Further, the light source 340 is configured to output light and the mechanism 365 can be used to position the filter 360 to overlap the light source 340 and the image sensor of the image capture component 330.

As noted above, the image application 310 can be firmware which is embedded onto the controller 320, the device 300, and/or a storage device coupled to the device 300. In another embodiment, the image application 310 is an application stored on the device 300 within ROM (read only memory) or on the storage device accessible by the device 300. In other embodiments, the image application 310 is stored on a computer readable medium readable and/or accessible by the device 300 or the storage device from a different location. The computer readable medium can include a transitory or a non-transitory memory.

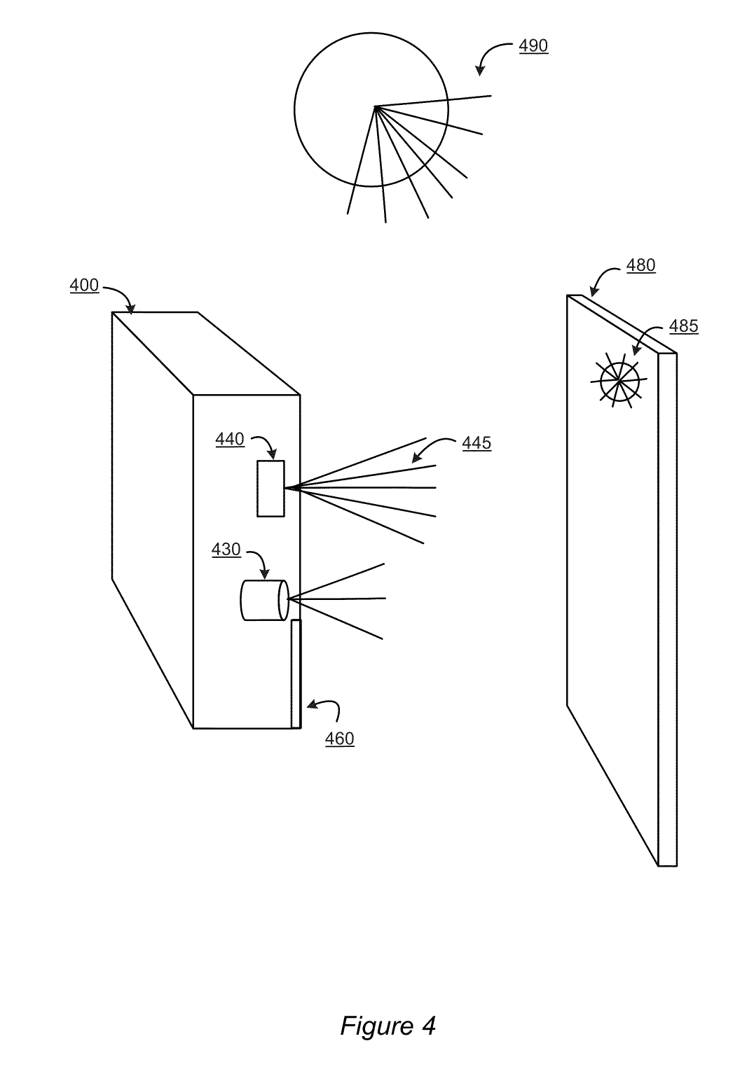

FIG. 4 illustrates an image capture component 430 detecting reflections 485 on a surface of media 480 according to an embodiment. The media 480 can be a document, a whiteboard and/or any additional physical media. Further, a surface or layer of the media 480 can be glossy or reflective. As a result, ambient light 490 or device outputted light 445 directed towards the surface of the media 480 can be reflected off the surface, leading to hot spots appearing on visual media captured by the image capture component 430. As shown in FIG. 4, ambient light 490 includes light which can be received from an ambient or natural light source. Additionally, device outputted light 445 is light produced from a device, such as a flash light or a strobe light of the device 400.

As noted above, a hot spot can be an over exposed area of captured visual media caused by light reflecting from the surface of the media 480. When detecting for a hot spot, the controller and/or the image application can use the image capture component 430 to detect for a reflection 485 on the surface of the media 480. In one embodiment, when detecting for a reflection 485, the filter 460 can initially be positioned to not overlap the image capture component 430 and the fight source 440. Additionally, the controller and/or the image application can instruct the light source 440 to output light onto the surface of the media 480. The controller and/or the image application can then instruct the image capture component 430 to capture a view of the surface of the media 480.

In response to capturing the view, the captured view can be stored as an image or a video within a memory buffer of device 400. The memory buffer can include volatile or non-volatile memory accessible to the controller and/or the image application. The controller and/or the image application can access the view from the memory buffer and detect for one or more hot spots.

In one embodiment, the controller and/or the image application can detect for a concentration of white or light colored pixels surrounded by darker pixels. If a large amount of white or light colored pixels are detected to be surrounded by dark pixels, the controller and/or the image application can determine that the corresponding area of the view is over exposed. As a result, the surface of the media 480 likely includes one or more hot spots resulting from reflections 485 on the surface of the media 480.

In another embodiment, when detecting for one or more hot spots, the controller and/or the image application can capture a first view using the light source 440 and subsequently capture a second view without the light source 440. The controller and/or the image application can then compare the first view and the second view to detect for brightness variations between the first view and the second view to determine whether hot spots are present. Corresponding areas between the first view and the second view with brightness variations can be identified by the controller and/or image application to be a hot spot. In other embodiment, other additional methods can be utilized by the controller and/or the image application to detect for hot spots and/or reflections on the surface 485 of the media 480,

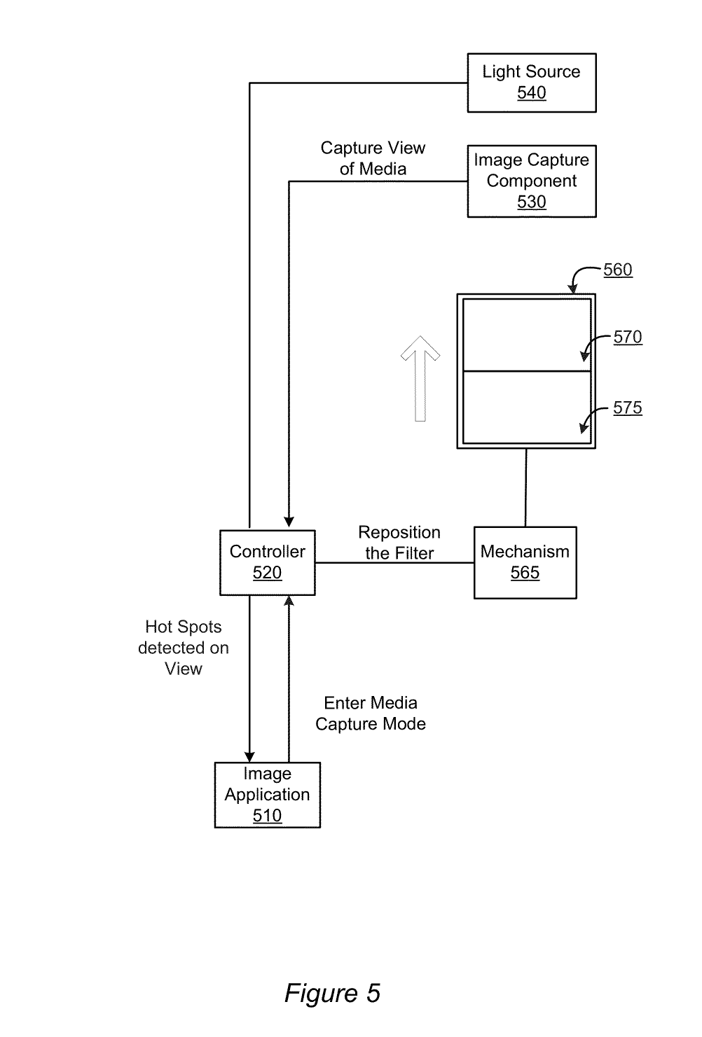

FIG. 5 illustrates a block diagram of a mechanism 565 for repositioning a filter 560 to cover a light source 540 and an image sensor of an image capture component 530 in response to detecting reflections according to an embodiment. As shown in the present embodiment, the image capture component 530 has captured a view of a surface of the media. In response, the controller 520 and/or the image application 510 access the view to detect for one or more hot spots.

As shown in FIG. 5, the controller 520 and/or the image application 510 have detected hot spots on the view. As a result, the controller 520 and/or the image application 510 determine that the surface of the media includes reflections and/or hot spots. In response, the controller 520 and/or the image application 510 enter or transition the device to a media capture mode. As noted above, the light source 540 and the image capture component 530 are enabled in the media capture mode. Additionally, the light source 540 is configured by the controller 520 and/or the image application 510 to output light in the media capture mode.

In one embodiment, in response to entering or transitioning into the media capture mode, the controller 520 and/or the image application 510 instruct the mechanism 565 to automatically reposition the filter 560. As noted above, the mechanism 565 can include a motor or spring to automatically reposition the filter 560, such that the first polarized portion 570 of the filter 560 overlaps the light source 540 and the second polarized portion 575 of the filter 560 overlaps an image sensor of the image capture component 530.

In another embodiment, the controller 520 and/or the image application 510 can prompt the user to manually reposition the filter 560 with the mechanism 565. The prompt can be a visual message or an audio message which can be outputted through a display component or an audio component of the device. In another embodiment, the prompt can be a vibration or haptic feedback generated from a motor of the device. As noted above, the user can manually access the mechanism 565 and reposition the filter 560 by sliding the filter 560 along a rail of the mechanism 565. In another embodiment, the user can manually access the mechanism 565 and reposition the filter by rotating the filter 560 around a hinge of the mechanism 565.

Once the filter 560 has been repositioned, such that the first polarized portion 570 of the filter 560 overlaps the light source 540 and the second polarized portion 575 of the filter 560 overlaps an image sensor of the image capture component 530, the controller 520 and/or the image application 510 can instruct the image capture component 530 to capture visual media of the media. In other embodiments, if no reflections or hot spots were detected by the controller 520 and/or the image application 510, the controller 520 and/or the image application 510 can instruct the image capture component 530 to capture the visual media without instructing the mechanism 565 to reposition the filter 560 and without issuing a prompt for the user to reposition the filter 560.

Additionally, if device exits the media capture mode, the controller 520 and/or the image application 510 can instruct the mechanism 565 to reposition the filter 560 such that the first polarized portion 570 and the second polarized portion 575 do not overlap the light source 540 and the image sensor of the image capture component 530. In another embodiment, the user can be prompted to reposition the filter 560 with the mechanism 565.

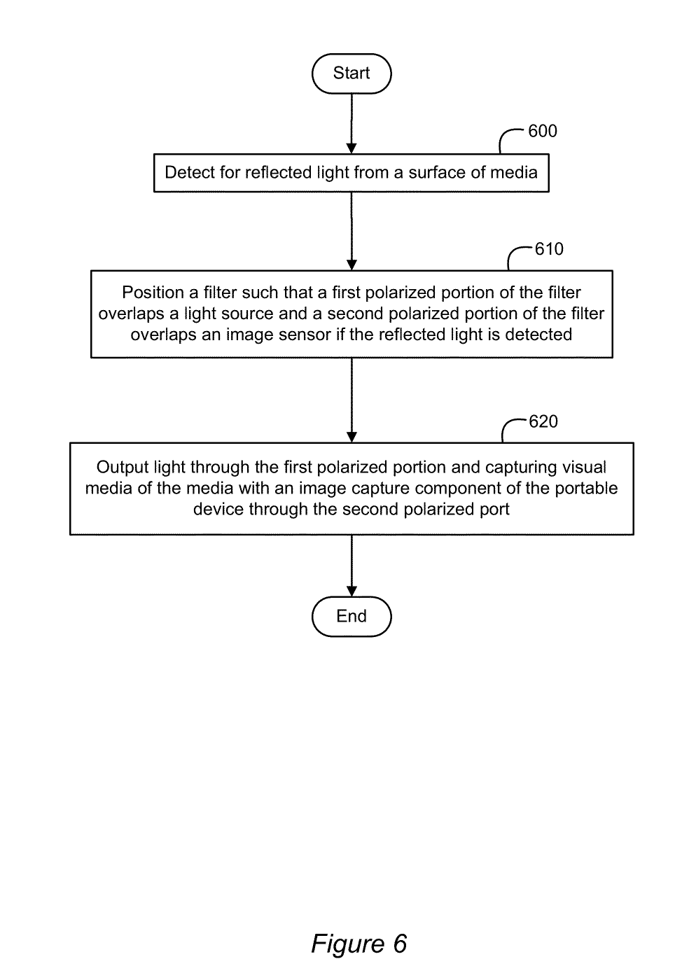

FIG. 6 is a flow chart illustrating a method for capturing visual media according to an embodiment. The method of FIG. 6 uses a device with a controller, an image capture component with an image sensor, a light source, a mechanism to reposition a filter, and/or an image application. In other embodiments, the method of FIG. 6 uses additional components and/or devices in addition to and/or in lieu of those noted above and illustrated in FIGS. 1, 2, 3, 4, and 5.

As noted above, the image application is an application which can be utilized independently and/or in conjunction with the controller to manage the device when capturing visual media. The visual media can be a two dimensional and/or a three dimensional image or video of media, such as a document, a whiteboard, and/or any additional physical media. The controller and/or the image application can initially use the image capture component to detect for reflected light from a surface of the media 600. In one embodiment, the image capture component can capture a view of the media.

The controller and/or the image application can access the view and detect for one or more hot spots on the view of the media. As noted above, a hot spot can be caused from fight reflecting from a surface of the media, resulting in over exposed areas of the captured view. If the controller and/or the image application detect any over exposed areas, a hot spot will be determined to be present. In one embodiment, the controller and/or image application can enter and/or transition the device to a media capture mode.

In response, a mechanism can be used to position a first polarized portion of a filter to overlap a light source of the device 610. Additionally, as noted above, the second portion of the filter will be positioned to overlap an image sensor of the image capture component. The mechanism is a hardware component of the device which can include a motor and/or spring to reposition the filter from one position to another. In one embodiment, a user of the device can use the mechanism to manually reposition the filter. In another embodiment, the mechanism can include a motor or spring to automatically reposition the filter.

As noted above, the first polarized portion and the second polarized portion of the filter can be linearly and orthogonally polarized. In another embodiment, the first polarized portion and the second polarized portion of the filter can both be circularly polarized. The controller and/or the image application instruct the light source to output light through the first polarized portion of the filter and instruct the image capture component to capture visual media of the media through the second polarized portion of the filter 620. As a result, an amount of reflections on the surface of the media can be reduced and the amount of hot spots on the captured visual media can be reduced. The method is then complete. In other embodiments, the method of FIG. 6 includes additional steps in addition to and/or in lieu of those depicted in FIG. 6,

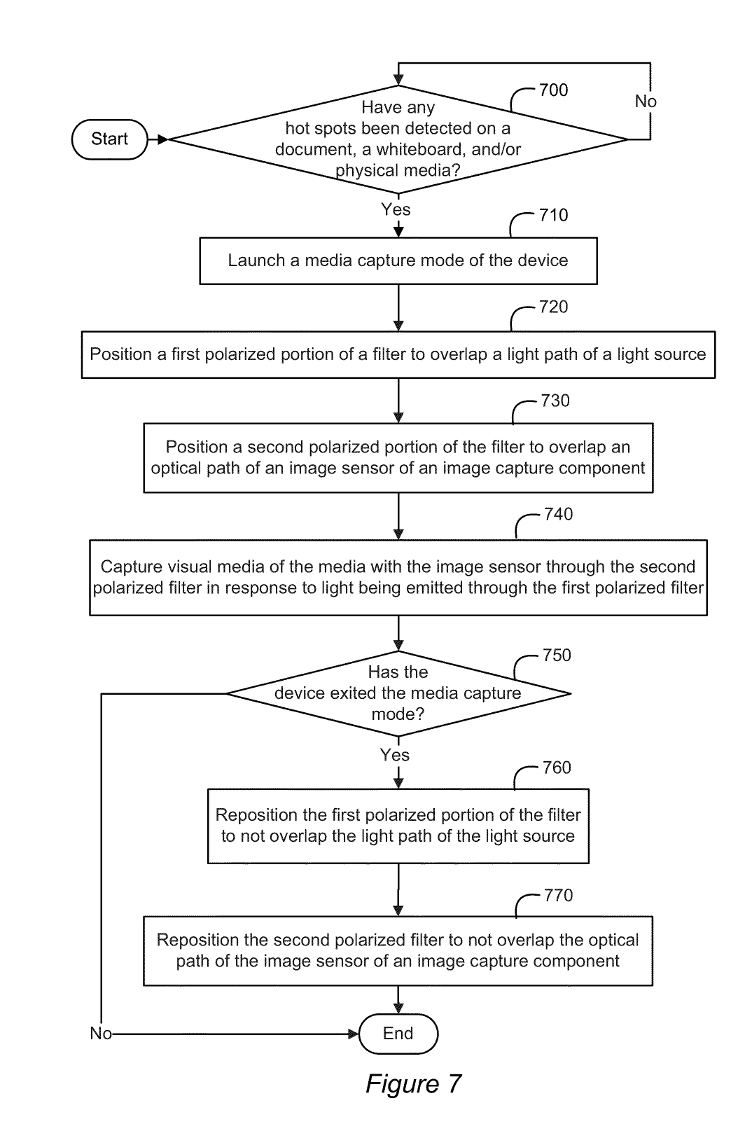

FIG. 7 is a flow chart illustrating a method for capturing visual media according to another embodiment. Similar to the method disclosed above, the method of FIG. 7 uses a device with a controller, an image capture component with an image sensor, a light source, a mechanism to reposition a filter, and/or an image application. In other embodiments, the method of FIG. 7 uses additional components and/or devices in addition to and/or in lieu of those noted above and illustrated in FIGS. 1, 2, 3, 4, and 5.

As noted above, the image capture component can initially capture a view of media. The media can be a document, a whiteboard, and/or any additional physical media. The controller and/or the image application can access the view of the media and determine whether any hot spots have been detected on the surface of the media 700. In one embodiment, the controller and/or the image application can detect for a concentration of white or light colored pixels indicating that the corresponding area of the view is over exposed. In another embodiment, a first view can be captured with the light source and a second view can be captured without the light source. The controller can compare the first view and the second view and detect for brightness variations.

If no over exposed areas were detected, the controller and/or the image application determine that no hot spots are detected on the captured view. The controller and/or the image application proceed to capture the visual media and continue to detect for one or more hot spots 700. In another embodiment, if any over exposed areas are detected, the controller and/or the image application determine that hot spots are present and proceed to launch a media capture mode of the device 710. The media capture mode is used to capture visual media and reduce hot spots on the captured visual media.

When entering the media capture mode, the controller and/or the image application can instruct a mechanism of the device to automatically reposition a filter to overlap the light source and overlap the image sensor of the image capture component. The mechanism can include a motor or spring reposition the filter by sliding or rotating the filter from one position to another. In another embodiment, a user can use the mechanism to manually reposition the filter to overlap the light source and the image sensor of the image capture component.

The mechanism can be used reposition the filter such that a first polarized portion of the filter overlaps a light path of the light source 720. Additionally, the mechanism can reposition the filter such that a second polarized portion of the filter overlaps an optical path of an image sensor of the image capture component 730. By overlapping the light path with the first polarized portion and overlapping the optical path with the second polarized portion, the polarized light outputted from the fight source can be filtered and the polarized light reflected from a surface of the media can be filtered for the image sensor to capture visual media of the image 740.

The controller and/or the image application can then determine if the device has exited the media capture mode 750. If the device remains in the media capture mode, the device can continue to capture visual media with the filter overlapping the light source and the image capture component and the method is complete. In another embodiment, if the device has exited the media capture mode, the controller and/or the image application instruct the mechanism to reposition the first polarized portion of the filter to not overlap the light path of the light source 760.

Additionally, the controller and/or the image application instruct the mechanism to reposition the second polarized portion of the filter to not overlap the optical path of the image sensor of the image capture component 770. The method is then complete. In other embodiments, the method of FIG. 7 includes additional steps in addition to and/or in lieu of those depicted in FIG. 7.

What is claimed is:

1. A portable device comprising:
a light source to output light;
an image capture component with an image sensor;
a filter with a first polarized portion and a second polarized portion;
a mechanism to reposition the filter to overlap the light source with the first polarized portion of the filter and overlap the image sensor with the second polarized portion of the filter; and
a controller to capture visual media with the image capture component.

2. The portable device of claim 1 wherein the first polarized portion of the filter and the second polarized portion of the filter are linearly polarized.

3. The portable device of claim 2 wherein the first polarized portion of the filter and the second polarized portion of the filter are orthogonally polarized relative to one another.

4. The portable device of claim 1 wherein the first polarized portion and the second polarized portion of the filter are circularly polarized.

5. The portable device of claim 1 wherein a user of the device can use the mechanism to reposition the filter by rotating or sliding the filter to overlap the light source and the image sensor of the image capture component.

6. The portable device of claim 1 wherein the mechanism includes a motor to reposition the filter.

7. The portable device of claim 1 wherein the visual media includes at least one of a document, a whiteboard, and physical media.

8. A method for capturing visual media comprising:
detecting for reflected light from a surface of media;
positioning a filter such that a first polarized portion of the filter overlaps a light source and a second polarized portion of the filter overlaps an image sensor if the reflected light is detected; and
outputting light through the first polarized portion and capturing visual media of the media with an image capture component of the portable device through the second polarized portion.

9. The method for capturing visual media of claim 8 wherein detecting for reflected light includes determining whether the media includes at least one hot spot from an ambient light source or a device outputted light source reflecting off the surface of the media.

10. The method for capturing visual media of claim 9 wherein determining whether the media includes at least one hot spot includes:
outputting light from the light source and capturing a first view;
capturing a second view without the light source; and
detecting for brightness variations between the first view and the second view.

11. The method for capturing visual media of claim 9 further comprising launching a media capture mode on the portable device in response to detecting at least one of the hot spot.

12. The method for capturing visual media of claim 9 wherein the filter does not overlap the image sensor of the image capture component and the light source if the reflected light is not detected on the surface of the media.

13. A portable device comprising:
a first polarized portion and a second polarized portion of a filter;
a light source to emit light;
an image capture component with an image sensor; and
a controller to reposition the filter with a mechanism of the device for the image capture component to capture visual media;
wherein the first polarized portion of the filter overlaps a light path of the light source and the second polarized portion of the filter overlaps an optical path of the image sensor to reduce reflections on the visual media being captured.

14. The portable device of claim 13 wherein the light source is a strobe light.

15. The portable device of claim 13 wherein the first polarized portion of the filter and the second polarized portion of the filter are at least one of linearly polarized, orthogonally polarized relative to one another, and circularly polarized.
